(19) United States
(12) Patent Application Publication
(10) Pub. No.: US 2009/0199185 A1
(43) Pub. Date: Aug. 6, 2009

(54) Affordances Supporting Microwork on Documents

(75) Inventors: Dean A. Slawson, Beijing (CN); Neema M. Moraveji, Rockville, MD (US); Filipe Fortes, Seattle, WA (US); David Zhang, Sydney (AU); Janine Michelle Perret, Seattle, WA (US); Christopher Edward Graves, Seattle, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/026,523

(22) Filed: Feb. 5, 2008

(51) Int. Cl. G06F 9/46

(52) U.S. Cl. 718/100

(57) ABSTRACT

Microwork customers may create microtasks and publish them with a microwork broker. Microwork providers may discover published microtasks and complete them in exchange for specified compensation. Microtask creation, publication, discovery and workflow facilities may be integrated into document editors, productivity tools, and the like. To facilitate trust and efficiency, particularly in the context of large public microwork brokers, public reputations may be maintained for microwork participants by the microwork broker. Distinct reputations may be maintained with respect to particular microwork categories. Discovery of microtasks, access to microtasks, selection of providers, and even compensation may be based on reputation. Microwork confidentially mechanisms, such as controlled access to specified portions of a microtask, or anonymization of portions of a workpiece not salient to a particular microtask, may be employed to protect potentially sensitive information while still taking advantage of the services of public microwork providers.

### BACKGROUND

Labor markets are a basic and effective aspect of modern work, facilitating an efficient division of labor. However, the granularity at which tasks may be practically divided and redistributed via markets has tended to be relatively coarse. Practical division of tasks has been limited by a variety of factors such as management overhead, skills availability, the difficulty of efficiently matching buyers and sellers, and issues surrounding confidentiality and trust. At times, these limits may become acute, particularly for knowledge workers. For example, as the complexity of knowledge work increases, knowledge workers have had to become ever more skilled or else suffer inefficiencies, risks and/or increased costs, for example, due to a lack of marketplace mechanisms designed for fine-grained knowledge work tasks.

The advent of computers, and particularly of communicatively linked networks of computers, has both helped and harmed the situation. On the one hand e-mail and various other collaborative applications have provided various levels of more or less ad hoc support for fine-grained task division. Also, the establishment of very large, highly connected pools of knowledge workers has become practical. On the other hand, they have enabled a significant increase in the complexity of knowledge work, and do little by default to facilitate the new knowledge worker marketplace. The situation has not gone completely unrecognized, and a variety of productivity, workflow, task marketplace and/or task management systems and methods have been introduced in an attempt to address various aspects. However, each of these conventional systems and methods has flaws.

For example, some conventional systems that explicitly provide support for productivity, workflow, task marketplace and/or task management functionality introduce almost as much inefficiency as they remove, or only provide significant efficiencies in very large and/or conventionally structured organizations or tasks. In the case of very small tasks, even the time required to locate and/or use a task management system or marketplace may exceed the benefits provided by conventional facilities. Some conventional systems fail to address confidentiality and/or trust issues that arise when utilizing resources external to an organization, and so prevent effective utilization of the significant resources that are available in today's very large public computer networks such as the internet. Some conventional systems are relatively rigidly structured around particular task types, and so provide effective support only for a relatively narrow range of tasks.

### SUMMARY

Efficient microwork is enabled, in particular with respect to document-related tasks. Microwork customers may create microtasks and publish them with a microwork broker. Microwork providers may discover published microtasks and complete them in exchange for specified compensation. Microtask creation, publication, discovery and workflow facilities may be integrated into, and made conveniently available from within, document editors.

To facilitate trust and collaborative efficiency, particularly in the context of large public microwork brokers, public reputations may be maintained for microwork participants by the microwork broker. To further enhance microwork efficiency, distinct reputations may be maintained with respect to particular microwork categories. Discovery of microtasks, access to microtasks, selection of providers such as matching of providers to customers, and even compensation may be based on reputation. Microwork confidentially mechanisms, such as controlled access to specified portions of a microtask, or anonymization of portions of a workpiece not salient to a particular microtask, may be employed to protect potentially sensitive information while still taking advantage of the services of public microwork providers.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 is a schematic diagram depicting an example computing environment in accordance with at least one embodiment of the invention.

FIG. 2 is a schematic diagram depicting an example high level microwork architecture in accordance with at least one embodiment of the invention.

FIG. 3 is a block diagram depicting an example microwork broker in accordance with at least one embodiment of the invention.

FIG. 4 is a schematic diagram depicting example details of a microwork architecture in accordance with at least one embodiment of the invention.

FIG. 5 is a block diagram depicting an example microwork module in accordance with at least one embodiment of the invention.

FIG. 6 is a block diagram depicting an example microwork customer data structure in accordance with at least one embodiment of the invention.

FIG. 7 is a block diagram depicting an example microwork provider data structure in accordance with at least one embodiment of the invention.

FIG. 8 is a block diagram depicting an example microwork participant data structure in accordance with at least one embodiment of the invention.

FIG. 9 is a block diagram depicting an example custom microtask data structure in accordance with at least one embodiment of the invention.

FIG. 10 is a block diagram depicting an example microtask data structure in accordance with at least one embodiment of the invention.

FIG. 11 is a flowchart depicting example steps for a microwork customer in accordance with at least one embodiment of the invention.

FIG. 12 is a flowchart depicting further example steps for a microwork customer in accordance with at least one embodiment of the invention.

FIG. 13 is a flowchart depicting still further example steps for a microwork customer in accordance with at least one embodiment of the invention.

FIG. 14 is a flowchart depicting example steps for a microwork provider in accordance with at least one embodiment of the invention.

FIG. 15 is a flowchart depicting example steps for microwork provider selection in accordance with at least one embodiment of the invention.

FIG. 16 is a flowchart depicting further example steps for a microwork provider in accordance with at least one embodiment of the invention.

The same numbers are used throughout the disclosure and figures to reference like components and features.

### DETAILED DESCRIPTION

The description first introduces terms and provides helpful context for the description referencing figures that follows. In an embodiment of the invention, efficient and relatively fine-grained task processing (“microwork”) is enabled, in particular with respect to electronic and/or computerized documents. As used herein, the term “microwork” includes division of work into relatively fine-grained tasks (“microtasks”), as well as distribution of microtasks to microwork providers. Examples of electronic and/or computerized documents include word processing documents, spreadsheets, electronic mail, scheduling data, contact information, slideshows, drawings, images, audio, video, multimedia documents, virtual reality environments and any suitable digital artifact subject to one or more editing processes.

Microwork customers may specify one or more microtasks for any suitable processing task, and may register or publish (“publish”) the microtasks at a computerized microwork broker such as may be maintained by a microwork service provider. Microwork providers may discover microtasks published at a microwork broker, and may complete microtasks in exchange for compensation, for example, as specified by the microtask. In particular, microwork creation, publication, discovery and workflow facilities may be integrated into, and made conveniently available from within, document editors. Examples of document editors include media editors, productivity tools, and any computer program capable of creating, reading, updating and/or deleting documents and/or one or more portions of documents.

The microwork broker may maintain reputations for both microwork customers and microwork providers (“microwork participants”). Such reputations may be based on microwork history as recorded by the microwork broker, for example, microtasks satisfactorily completed, time to microtask completion, or compensation paid out, and/or on explicit participant feedback with respect to particular microtasks. Microwork participants may have general reputations as well as reputations specific to particular categories of microwork. Microwork reputations may include one or more reputation scores, and such reputation scores may be determined in accordance with one or more reputation scoring methods, for example, adapted to particular marketplaces and/or microwork categories.

The microwork broker may manage workflow to facilitate efficient completion of microtasks. The microwork broker may match microwork providers to microwork customers based on criteria such as reputation, pricing and availability. Furthermore, discovery of microtasks, access to microtasks, and even compensation may be based on reputation. Thus reputation may be utilized by the microwork broker, as well as microwork customers and providers, as a proxy for trust, and to enhance efficiency, particularly in large public (and even pseudo-anonymous) service marketplaces.

A microwork architecture in accordance with an embodiment of the invention enables microwork customers to employ microwork providers through public microwork brokers while maintaining due care for potentially sensitive information by utilizing one or more microwork confidentiality facilities. For example, in addition to prescreening by reputation and/or group affiliation, microwork customers may require that microwork providers explicitly request access to confidential documents, microtasks, or portions of a microtask and manually grant access on a case-by-case basis. In addition, portions of a microtask not salient to completion of the microtask may be anonymized. For example, in a design-type microtask, sensitive document contents may be replaced by filler text (e.g., “greeked” text, obfuscated text, pseudorandom text, or the like) having one or more similar presentation characteristics.

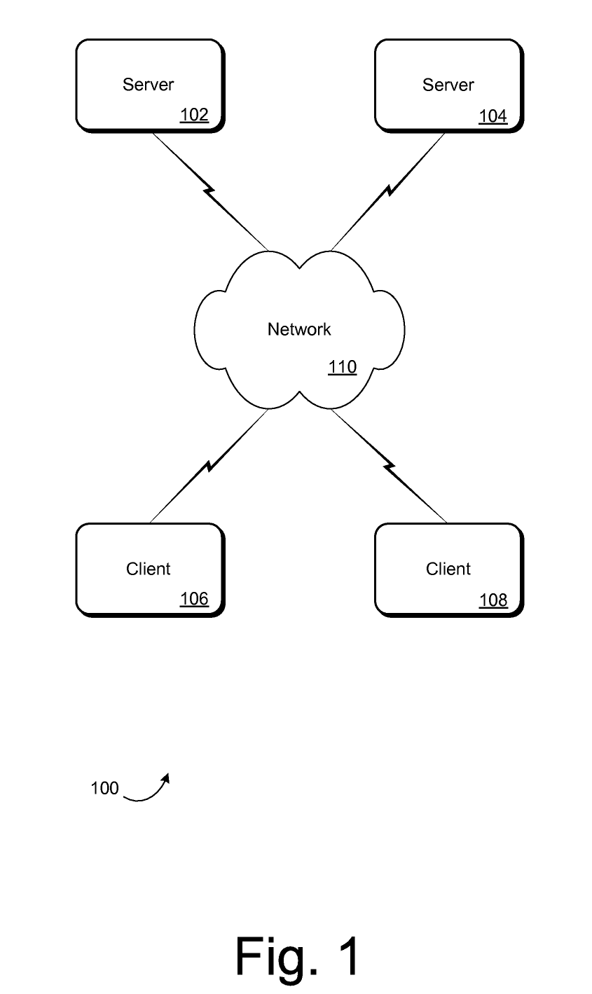

Before describing aspects of microwork architecture in accordance with an embodiment to the invention in more detail, it will be helpful to have reference to an example computing environment suitable for incorporating such. FIG. 1 depicts a suitable computing environment 100. The computing environment 100 depicts four computers 102, 104, 106, 108 connected by a network 110. For clarity, two of the computers 102, 104 are designated as servers, and two of the computers 106, 108 are designated as clients. Embodiments of the invention are not so limited and may include any suitable number of computers, servers and/or clients. Furthermore, as will be apparent to one of skill in the art, any of the computers 102, 104, 106, 108 may perform in multiple roles so that, for example, the computer 104 may change roles to become a client or act as both server and client simultaneously.

The computers 102, 104, 106, 108 may be any suitable computing device. Examples of suitable computing devices include mainframes, minicomputers, server-class computers, desktop computers, personal computers (PCs), workstations, portable computers, laptop computers, tablet computers, surface computers, personal digital assistants (PDAs), mobile devices such as mobile telephones, programmable consumer electronics devices, routers, gateways, switches, hubs, and suitable combinations thereof. The computers 102, 104, 106, 108 may include one or more processing units capable of executing instructions to perform tasks, as well as one or more types of computer-readable media such as volatile and/or non-volatile memory capable of storing data, computer programs and/or computer program components. Such computer programs and components may include executable instructions, structured data and/or unstructured data organized into modules, routines and/or any suitable programmatic object. Such computer programs and components may be created by and/or incorporate any suitable computer programming language.

The computers 102, 104, 106, 108 may include a wide variety of input/output (I/O) devices not shown in FIG. 1 such as keyboards, keypads, touchpads, touchscreens, mice, trackballs, pens, joysticks, gamepads, scanners, cameras, microphones, monitors, liquid crystal displays (LCDs), light emitting diodes (LEDs), printers and/or speakers. Examples of computer-readable media suitable for reading by the computers 102, 104, 106, 108 include any one or more of magnetic media (such as hard disks and flash drives), optical media such as compact disks (CDs) and communication media. Communication media may include any one or more of wired communication media such as copper wire, coaxial cable and optical fiber, as well as wireless communication media such as electro-magnetic media including radio, microwave, infra-red and laser light. In an embodiment of the invention, computer-readable media is tangible.

For clarity, embodiments of the invention may be described herein with reference to symbolic operations such as those of a computer programming language. Such symbolic operations and any data that they act upon correspond to physical states of components and changes in components of computing devices such as the computers 102, 104, 106, 108 in a manner well understood by one of skill in the art. In an embodiment of the invention, each such operation and its associated data may be fully implemented in hardware.

The network 110 may include any suitable network element and/or communication media. A computing device is an example of a suitable network element. The network 110 may incorporate any suitable network topology. Examples of suitable network topologies include simple point-to-point, star topology, self organizing peer-to-peer topologies and combinations thereof. Furthermore, the network 110 may employ any suitable network protocol to establish and/or maintain connectivity between the computers 102, 104, 106, 108. Examples of suitable network protocols include telephonic protocols, transmission control protocols (TCP), and internet protocols (IP), and suitable combinations thereof.

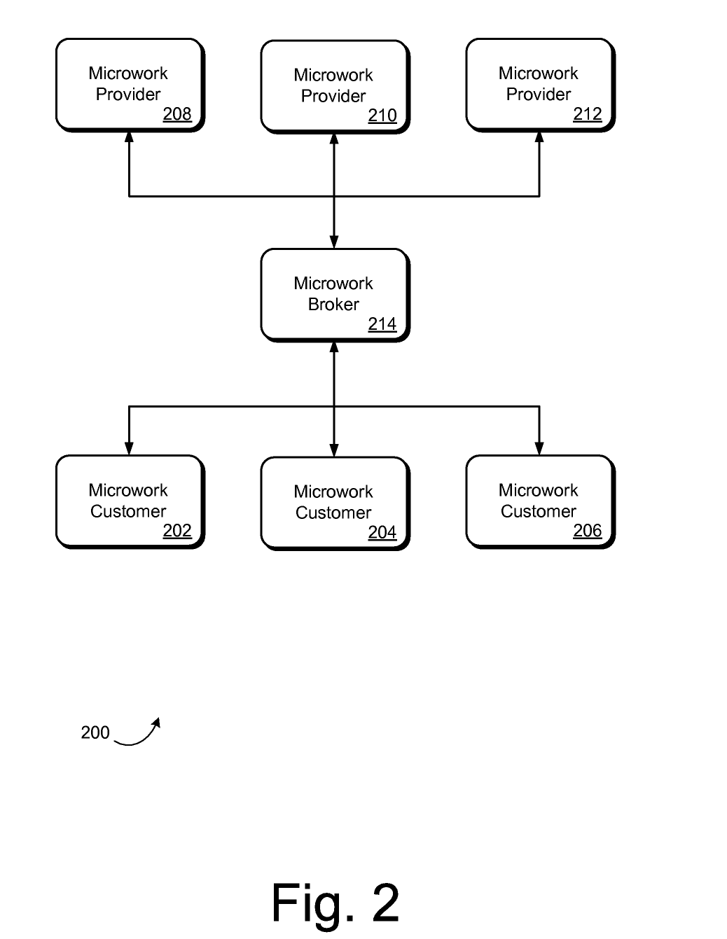

FIG. 2 depicts an example high level microwork architecture 200 in accordance with at least one embodiment of the invention. In the microwork architecture 200, one or more microwork customers 202, 204, 206 may interact with one or more microwork providers 208, 210, 212 through a microwork broker 214. The microwork customers 202, 204, 206 may create microtasks and publish them at the microwork broker 214. The microwork providers 208, 210, 212 may discover microtasks published at the microwork broker 214, for example, by submitting microtask search queries or by receiving microtask publication notifications in accordance with one or more microwork subscriptions (as described below in more detail with reference to FIG. 7), and take on microtasks suited to their skill set. As described in more detail below, the microwork broker 214 may manage matching of microwork customers 202, 204, 206 to microwork providers 208, 210, 212, microwork workflow, and microwork provider compensation.

As an illustrative example, suppose microwork customer 202 is preparing a set of electronic documents for a business meeting. While preparing each document, microwork customer 202 may identify one or more microtasks suitable for completion by a microwork provider such as the microwork providers 208, 210, 212. Examples of microtasks include document editing, document formatting, provision of specialist content such as graphics, video and audio, provision of non-specialist content, document proofreading, document translation, graphic design, document template creation and/or modification, tasks requiring and/or more efficiently performed with specialist document editing programs, and any suitable document-related task that may benefit from a microwork provider 208, 210, 212 skill set. The microwork customer 202 may specify each identified microtask and publish them to the microwork broker 214, for example, from within an associated document editor.

The microwork broker 214 may maintain a database of published microtasks and a user interface to the database. The user interface may include elements from any suitable type of user interface including graphical user interfaces (GUIs), web sites, text-based user interfaces, interactive voice response (IVR) systems, mobile device enhanced user interfaces including user interfaces incorporating voice prompts, touch tone and/or speech recognition inputs, keypad-based user interfaces, and user interfaces optimized for mobile class touchscreens. The microwork providers 208, 210, 212 may utilize the user interface to discover the published microtasks. Discovery of published microtasks may include notification by email or other suitable notification mechanism. Each of the published microtasks may be associated with a set of terms and conditions, in particular, a compensation scheme. As described in more detail below, each microwork provider 208, 210, 212 may reserve, or apply to reserve, microtasks associated with terms and conditions they find agreeable and which match their skill sets and availability. Each microwork provider 208, 210, 212 may have an associated reputation that privileges or hinders them, for example, with respect to microwork preferences such as preferred classes of microtask, preferred compensation schemes and preferred customers.

Suppose in this example that microwork provider 208 reserves and completes a ten page translation microtask, microwork provider 210 reserves and completes a document formatting task, but microwork provider 212 is newly associated with the microwork broker 214 and consequently has a reputation below the threshold set by the microwork customer 202 even to discover the microtasks published by the microwork customer 202. The microwork providers 208 and 210 may communicate with the microwork customer 202 prior to, during and/or after microtask processing, for example, to clarify the microtask, negotiate the terms and conditions, perform work, review work, and/or to assist in settling transactions. The microwork broker 214 may facilitate such communications. Such communications may be real-time and/or employ any suitable mode of communications. Alternatively, such communications may be “out of band”, for example, utilizing any suitable conventional communication system or method. Similarly, the microwork broker 214 may facilitate communication of microtask deliverables from the microwork providers 208, 210 to the microwork customer 202, and/or the deliverables may be communicated out-of-band.

In this example, the ten page translation may simply be added to the set of documents being prepared by the microwork customer 202 as a new document. However, it may be that the document formatting microtask does not require viewing of the document content. In this case the associated microtask may include a workpiece document wherein confidential text is replaced with filler text, and the microtask deliverable may be a formatted version of the workpiece document, a set of computer-readable instructions that perform the microtask (e.g., a document editor “macro” or instructions corresponding to user interface “telepointer” actions), a written description of how to complete the microtask, or any suitable deliverable that enables a completion of the microtask acceptable to the microwork customer.

Following completion, the microwork customer 202 may interact with the microwork broker 214 to update the reputations of the microwork providers 208 and 210, for example, based on the deliverables associated with the completed microtasks. The microwork broker 214 may facilitate compensation for the completed microtasks, for example, in accordance with compensation schemes specified by the microtasks. Alternatively, compensation may take place out-of-band. The microwork providers 208, 210 may similarly interact with the microwork broker 214 to update the reputation of the microwork customer 202, for example, based on the compensation.

Although the microwork architecture 200 shows only one microwork broker 214, as will be apparent to one of skill in the art, each embodiment of the invention is not so limited. For example, a cluster or network (including a self-organizing network) of suitably adapted microwork brokers may serve in the role of the microwork broker 214. Furthermore, each microwork broker such as the microwork broker 214 may be implemented with and/or incorporate one or more computers such as the computers 102, 104, 106, 108 of FIG. 1.

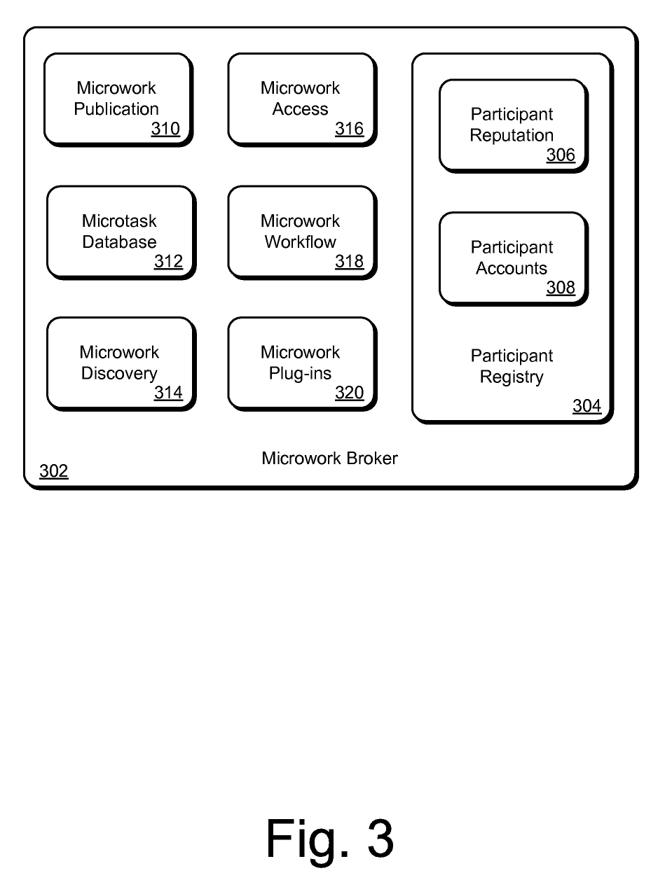

FIG. 3 depicts an example microwork broker 302 in accordance with at least one embodiment of the invention. The microwork broker 302 may include a participant registry 304 that may maintain microwork participant profiles and, in particular, participant reputation 306 and participant accounts 308 (including financial accounts and the like). The microwork broker 302 may include a microwork publication module 310 that facilitates publication of microtasks, for example, by microwork customers 202, 204, 206 (FIG. 2). The microwork broker 302 may include a microtask database 312 capable of storing published microtasks. Although shown as distinct in FIG. 3, the microtask database 312 may alternatively be incorporated into the microwork publication module 310. The microwork publication module 310 may provide a programmatic interface (including a remotely accessible programmatic interface) that includes functionality to read and/or update the microtask database 312.

The microwork broker 302 may include a microwork discovery module 314 that facilitates discovery of published microtasks, for example, by microwork providers 208, 210, 212 (FIG. 2). The microwork discovery module 314 may include a programmatic interface (including a remotely accessible programmatic interface) that includes functionality to monitor and/or search the microtask database 312. For example, the microwork discovery module 314 may be configured to monitor the microtask database 312 for newly published microtasks and to notify microwork participants in the participant registry 304 having microwork subscriptions that match the newly published microtasks. Alternatively, or in addition, microwork providers 208, 210, 212 may utilize the programmatic interface of the microwork discovery module 314 to search the microtask database 312. The microwork discovery module 314 may filter search results based on microtask specifications, participant registry 304 information, and/or any suitable criteria.

The microwork broker 302 may include a microwork access module 316 to manage access to published microtasks specified as requiring authorization to access. The microwork broker 302 may include a microwork workflow module 318 that facilitates efficient assignment of, completion of and compensation for microtasks. The microwork workflow module 318 may furthermore facilitate notification of progress delays (e.g., beyond a specified threshold), and microtask reassignment (e.g., to a preferred microwork provider who becomes available). The microwork broker 302 may include one or more microwork plug-ins 320 suitable for downloading to microwork customers 202, 204, 206 (FIG. 2) and/or microwork providers 208, 210, 212 to facilitate interaction with the microwork broker (including notification, for example, of task status), interaction with any suitable productivity tool, internet browser, computer operating system or the like, and/or creation or completion of a microtask.

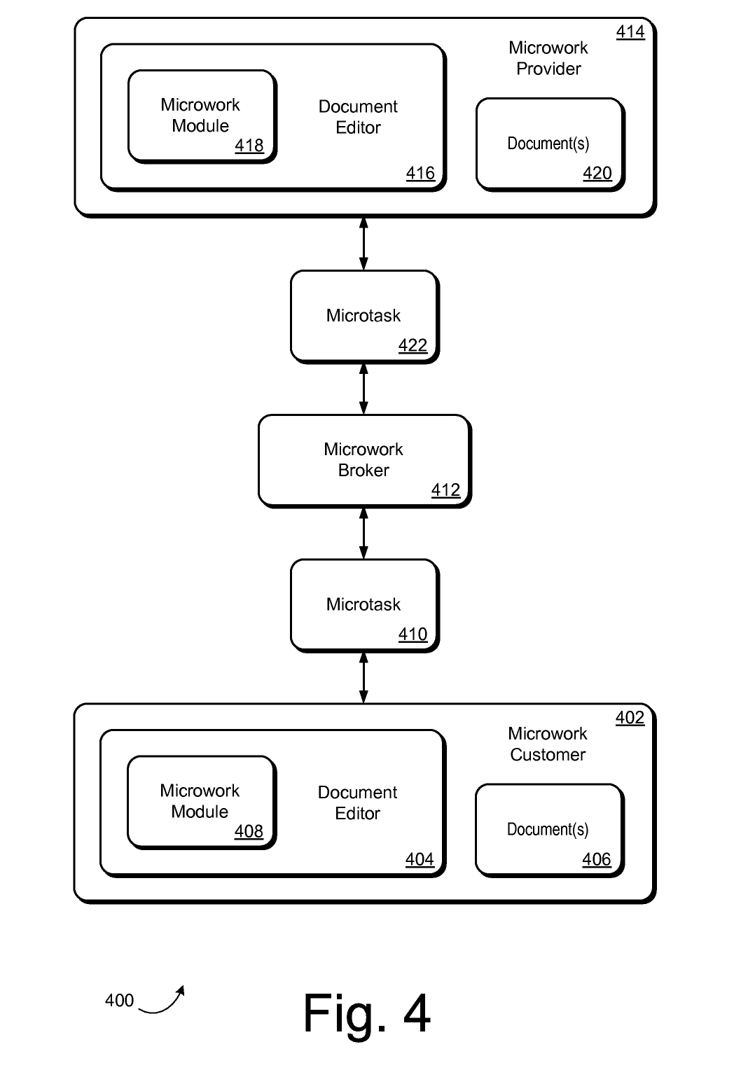

FIG. 4 depicts example details of a microwork architecture 400 in accordance with at least one embodiment of the invention. In particular, the microwork architecture 400 includes details relevant to utilizing microwork for document-related tasks. The microwork architecture 400 includes a microwork customer 402 utilizing a document editor 404 (such as a word processing program) to edit one or more documents 406. The microwork customer 402 is a suitable example of the microwork customers 202, 204, 206 of FIG. 2. The microwork customer 402 may correspond to a computer system and may be implemented with, and/or incorporate, one or more computers such as the computers 102, 104, 106, 108 of FIG. 1. Although not shown in FIG. 4, the microwork customer 402 may include a computer operating system and/or a user interface such as a graphical user interface (GUI). The microwork customer 402 typically corresponds to a single person, however each embodiment of the invention is not so limited. In particular, the microwork customer 402 may correspond to an organization.

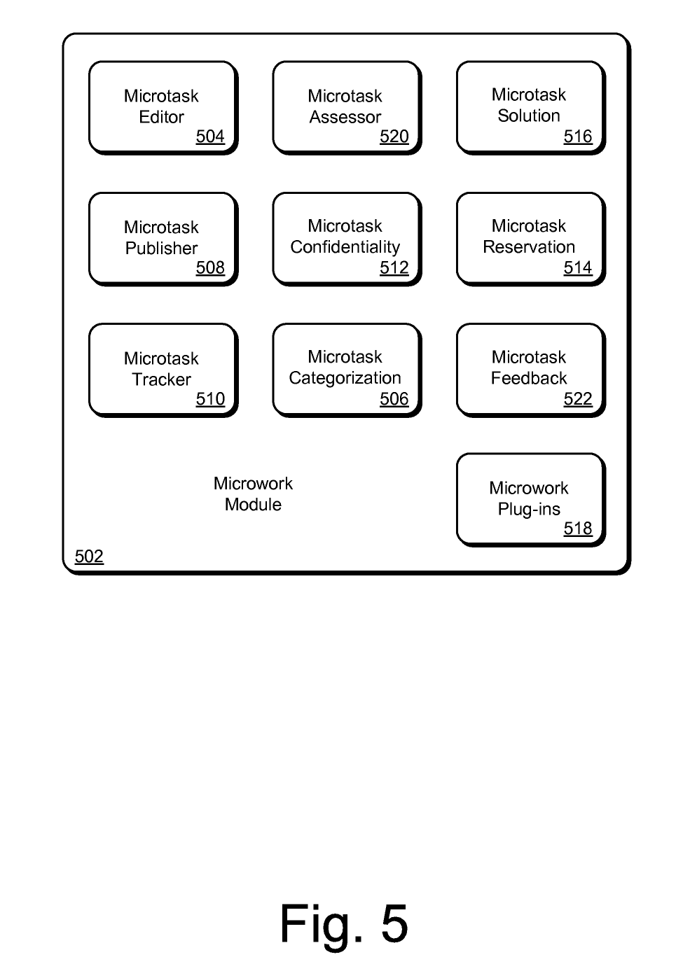

The document editor 404 includes a microwork module 408 that may facilitate creation of microtasks, such as the microtask 410, as well as interaction with a microwork broker 412. For example, the microwork module 408 may implement a “create microtask” menu item of the document editor 404. In response to selection of the menu item, the microwork module 408 may collect information required to specify the microtask 410. For example, the microwork module 408 may collect information from the document editor 404, extract relevant information from the document(s) 406 and/or a context thereof, and/or prompt the user for the required information with one or more user interface elements. Having facilitated creation of the microtask 410, the microwork module 408 may facilitate publishing of the microtask 410, for example, by communicating the microtask 410 to the microwork broker 412. Further example microwork module 408 details are described below with reference to FIG. 5.

The microwork broker 412 is a suitable example of the microwork broker 214. The microtask 410 is depicted between the microwork customer 402 and the microwork broker 412 to highlight that, after creation at the microwork customer 402, it may be communicated to the microwork broker 412 for publication. As will be apparent to one of skill in the art, the microtask 412 need not be communicated in a single protocol message, and any suitable communication protocol may be utilized, including suitable replication and synchronization protocols.

The microwork architecture 400 further includes a microwork provider 414. The microwork provider 414 may similarly utilize a document editor 416 with an integrated microwork module to edit one or more documents 420. The document editor 416 need not be the same as the document editor 404. In particular the document editor 416 may be a different version of the document editor 404. Although, for clarity, FIG. 4 depicts the microwork customer 402 and the microwork provider 414 as each including a single document editor 404 and 416 respectively, of course each embodiment of the invention is not so limited and either the microwork customer 402 and/or the microwork provider 414 may include any suitable number of document editors and, for example, may include different document editors for different document types and/or document processing tasks.

Furthermore, although in this example, the microwork modules 408, 418 are identical, again each embodiment of the invention is not so limited and, in particular, the microwork modules may have differing versions and/or be specialized for the microwork customer 402 and/or the microwork provider 414. Examples of situations in which the microwork modules 408, 418 may have differing versions include the microwork modules 408, 418 being implemented for differing computer operating systems, and one or more of the microwork customer 402 and the microwork provider 414 failing to upgrade to the latest version of the microwork module 408, 418 and/or the document editor 404, 416. Examples of situations in which the microwork modules 408, 418 may be specialized for the microwork customer 402 and/or the microwork provider 414 include the asymmetry in workflow between microwork customer 402 and microwork provider 414 becoming significant, where the microwork provider 414 provides some particularly specialized service, and where one of the document editors 404, 416 is unsuited to functionality provided by a particular specialized microwork module. The microwork provider 414 is a suitable example of the microwork providers 208, 210, 212 (FIG. 2).

The microwork provider 414 may discover suitable microtasks at the microwork broker 412 and may retrieve some or all (as in this example) of a suitable microtask 422 to the microwork provider 414 in order to work on it. In particular, the microtask 410 may include a version of the document(s) 406. The microtask 422 may be a version of the microtask 410 (or simply a copy as in this example), and the document(s) 420 may be a version of the document(s) 406 which the microwork provider 414 works to edit in accordance with the specifications of the microtask 422. Each of the documents 406 and 420 may be associated with one or more identifiers such as a filename. Associated documents, and associated versions in particular, may be associated with identifiers having one or more matching portions. Furthermore, each of the microtasks 410 and 422 may be associated with one or more identifiers such as a universally unique identifier (UUID). Again, associated microtasks, and associated versions in particular, may be associated with identifiers having one or more matching portions. Some microwork brokers such as the microwork broker 412 may furthermore enhance the microtask 422 and/or the document(s) 420 with respect to the microtask 410 and/or the document(s) 406, for example, with document transformations and/or annotations that facilitate an efficiency, creativity and/or effectiveness of the microwork provider 414. For example, such enhancements may be performed by the microwork workflow module 318 (FIG. 3) of the microwork broker 412.

FIG. 5 depicts an example microwork module 502 in accordance with at least one embodiment of the invention. The microwork module 502 is a suitable example of the microwork modules 408, 418 of FIG. 4. The microwork module 502 may include a microtask editor 504 capable of creating, editing and/or updating microtasks such as the microtask 410. The microwork module 502 may include a microtask categorization module 506 capable of automatically categorizing microtasks, for example, given the context of the creation. The microwork module 502 may further include a microtask publisher 508 capable of publishing microtasks to a microtask broker such as the microtask broker 412. The microwork module 502 may still further include a microtask tracker 510 capable of updating and/or viewing a status of a microtask. Microtask status updates may include microtask progress updates and notifications of anticipated delays.

For certain categories of microtask, it is possible for the microtask to be successfully completed without full access to associated document contents. For example, some graphic design microtasks need only general presentation characteristics of associated document contents. In such cases, it may be possible to lower the required level of trust for a particular microtask, and thus broaden the pool of potential microwork providers, by anonymizing the associated document contents. In some cases, restricting access to particular document portions may be effective. The microwork module 502 may further include a microtask confidentiality module 512 capable of anonymizing and de-anonymizing portions of microtask (e.g., of a workpiece or document), as well as setting, updating and/or enforcing confidentiality restrictions on microtasks, for example, requiring authorization before accessing protected portions of a microtask. Simple examples of content anonymization include replacing document text with filler text or graphics having reasonably similar presentation characteristics. However, any suitable document content anonymization, obfuscation and/or screening technique may be employed by the microtask confidentiality module 512.

The microwork module 502 may still further include a microtask reservation module 514 capable of facilitating reservation of microtasks by microwork providers, although particular microtasks may not be reservable depending on microtask and/or microwork broker configuration. The decision to allow reservations for a particular category of microtask can be complex, and can depend upon a particular microwork community as much as the nature of the microwork category. For example, in one microwork community technically-oriented microtasks may be completed quickly without requiring microtask reservations, whereas in another microwork community such microtasks may be perceived as high-effort and high-risk without a reservation scheme in place. The reservation module 514 may therefore be configurable to implement microtask reservation policy, for example, at microwork broker and microtask category levels.

The microwork module 502 may include a microwork solution module 516 to facilitate completion of microtasks by microwork providers, as well as communication of completed microtasks to microwork brokers and/or customers. The microwork module 502 may include one or more microwork plug-ins 518, for example, downloaded from the microwork broker 302 (FIG. 3). Such microwork plug-ins 518 may extend the capabilities of document editors such as the document editors 404, 416 of FIG. 4. Furthermore, in contrast to the example depicted in FIG. 4, ones of the microwork plug-ins 518 may, for example, be fully fledged document editors, with the microwork module 502 providing a computing environment in which they execute.

The microwork module 502 may include a microwork assessor module 520 capable of facilitating assessment of completed microtasks. The microwork module 502 may include a microtask feedback module 522 capable of facilitating feedback associated with microtasks. Such feedback may be utilized by the microwork broker 302 (FIG. 3) to update participant reputations 306.

The description now turns to details of data structures that may be created, read, updated and/or deleted by microwork architectures such as the microwork architecture 200 (FIG. 2) and/or the components thereof. Such data structures are integral with systems and methods in accordance with at least one embodiment of the invention, and each such data structure may be embodied in one or more tangible computer-readable media.

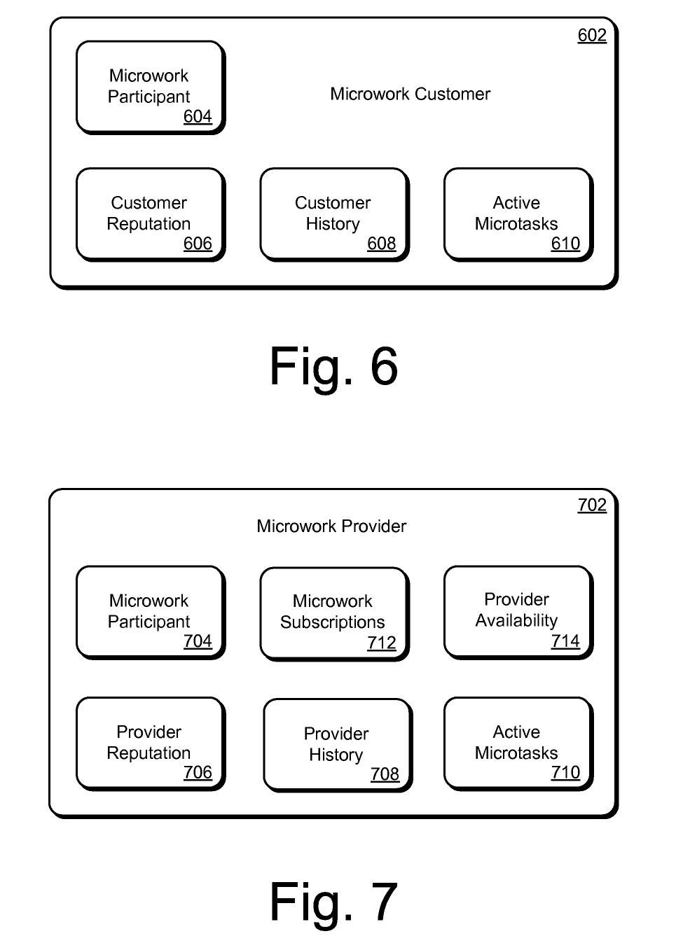

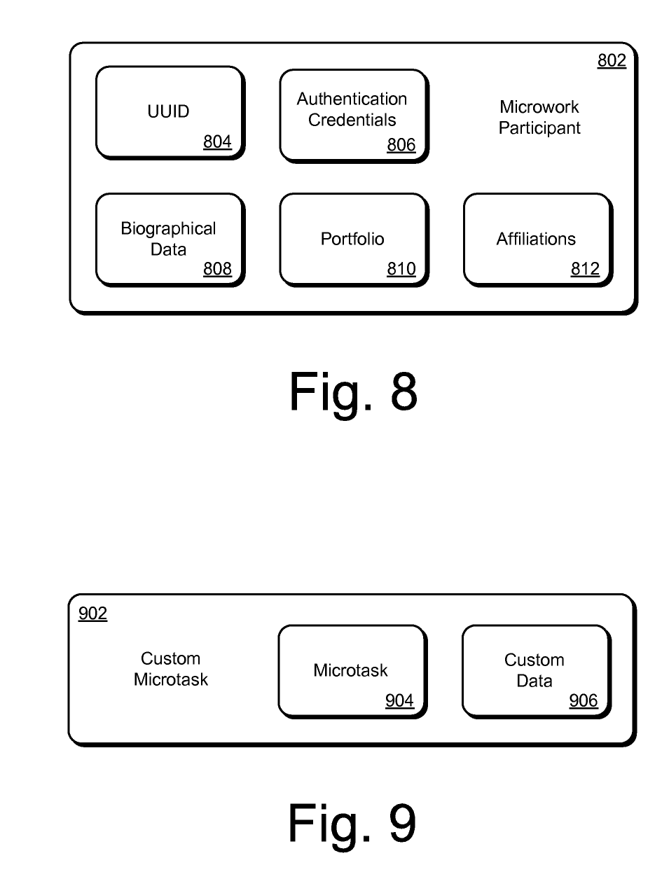

FIG. 6 depicts an example data structure 602 corresponding to a microwork customer in accordance with at least one embodiment of the invention. For example, the data structure 602 may be maintained by the microwork broker 302 (FIG. 3) as part of the participant registry 304. The microwork customer data structure 602 may include a microwork participant data structure 604 (or reference thereto). An example microwork participant data structure is described below in more detail with reference to FIG. 8.

The microwork customer data structure 602 may further include a customer reputation 606, a customer history 608 (including microtask history), and/or a set of active microtasks 610. The customer reputation 606 may include feedback from microwork providers 208, 210, 212 (FIG. 2) associated with microtasks published by the microwork customer associated with the data structure 602. The customer reputation 606 may further include one or more reputation scores summarizing and/or corresponding to the feedback (e.g., percent positive feedback, percent neutral feedback, and percent negative feedback). For example, reputation scores may be maintained by the microwork workflow module 318 (FIG. 3) of the microwork broker 302. Reputation scores may be based on any suitable parameter associated with the microwork customer 602, and may be calculated in accordance with any suitable scoring formula including scoring formulas incorporating linear and non-linear functions. In particular, scoring formulas may distinguish between different microtask categories.

The customer history 608 may include a log of microwork activity including microtask creation, publication, and compensation provided for microtasks. Any suitable aspect of microwork history, including copies and/or mementos of microtasks 410 (FIG. 4), may be included in the customer history 608. The customer history 608 may further include summary statistics such as number of microtasks published and number of microtasks canceled. The set of active microtasks 610 may include and/or reference microtasks published by the microwork customer associated with the data structure 608 and not yet completed or canceled.

FIG. 7 depicts an example data structure 702 corresponding to a microwork provider in accordance with at least one embodiment of the invention. The data structure 702 may be utilized by the microwork broker 302 (FIG. 3) as part of the participant registry 304, and as the counterpart of the microwork customer data structure 602 (FIG. 6). As with the microwork customer data structure 602, the microwork provider data structure 702 may include and/or reference a microwork participant data structure 704. The microwork participant data structures 604, 704 may include information common to microwork customers and providers.

The microwork provider data structure 702 may further include a provider reputation 706, a provider history 708 (including microtask history), and/or a set of active microtasks 710. Although similar to the customer reputation 606 (FIG. 6), customer history 608, and the set of active microtasks 610 of the microwork customer data structure 602, the corresponding microwork provider 702 structures may have points of difference. For example, the provider reputation 706 may include feedback with regard to completed microtasks in contrast to fair payment for completed microtasks, and this feedback need not be the same. Associated reputation scores may be different and/or differently determined. The provider history 708 may include a log of microtask activity including microtask reservation, microtask status updates, and microtask completion. Any suitable aspect of microwork history, including copies and/or mementos of microtasks 422 (FIG. 4), may be included in the provider history 708. The set of active microtasks 710 may include and/or reference microtasks currently in progress, microtask awaiting payment and/or feedback.

The microwork provider data structure 702 may still further include a set of microwork subscriptions 712 and a provider availability 714. The microwork subscriptions 712 may specify types and/or categories of microtasks in which the microwork provider associated with the data structure 702 is interested. For example, the microwork broker 302 (FIG. 3) may send explicit notification of published microtasks to the microwork provider associated with the data structure 702 when the published microtasks fall with the specifications of the microwork subscriptions 712. The microwork subscriptions 712 may be updated explicitly by the microwork provider and/or automatically by the microwork broker 302, for example, based on the provider history 708. The provider availability 714 may specify time periods during which the microwork provider associated with the data structure 702 is available to complete microtasks. For example, the provider availability 714 may include a schedule.

FIG. 8 depicts an example microwork participant data structure 802 in accordance with at least one embodiment of the invention. The microwork participant data structure 802 may include a universally unique identifier (UUID) 804, a set of authentication credentials 806, biographical data 808, a portfolio 810 and/or a set of group affiliations 812. For example, the microwork participant data structure 802 may be maintained by the participant registry 304 (FIG. 3) of the microwork broker 302. The participant registry 304 may provide one or more user interfaces, for example, a portion of a web site, enabling microwork participants to create, read, update and/or delete microwork participant data structures 802. The set of authentication credentials 806 may be established during initial registration, and utilized thereafter to verify a participant's identity. In at least one embodiment of the invention, the set of authentication credentials 806 may be partial, virtual or stored independent of the participant data structure 802 to enhance marketplace security.

For example, the biographical data 808 may include a name, a photograph, a description, a resume, contact information and the like. Alternatively, or in addition, the biographical data 808 may include one or more advertisements and/or advertising related resources such as graphics, video, audio, and the like. The portfolio 810 may include and/or reference example microtasks published and/or completed. The group affiliations 812 may specify personal, professional, corporate group affiliations, and the like. It may be that the microwork broker 302 (FIG. 3) automatically assigns particular group affiliations to microwork participants based on achievements or other criteria. For example, member of the 1000 microtasks completed club, or member for X years.

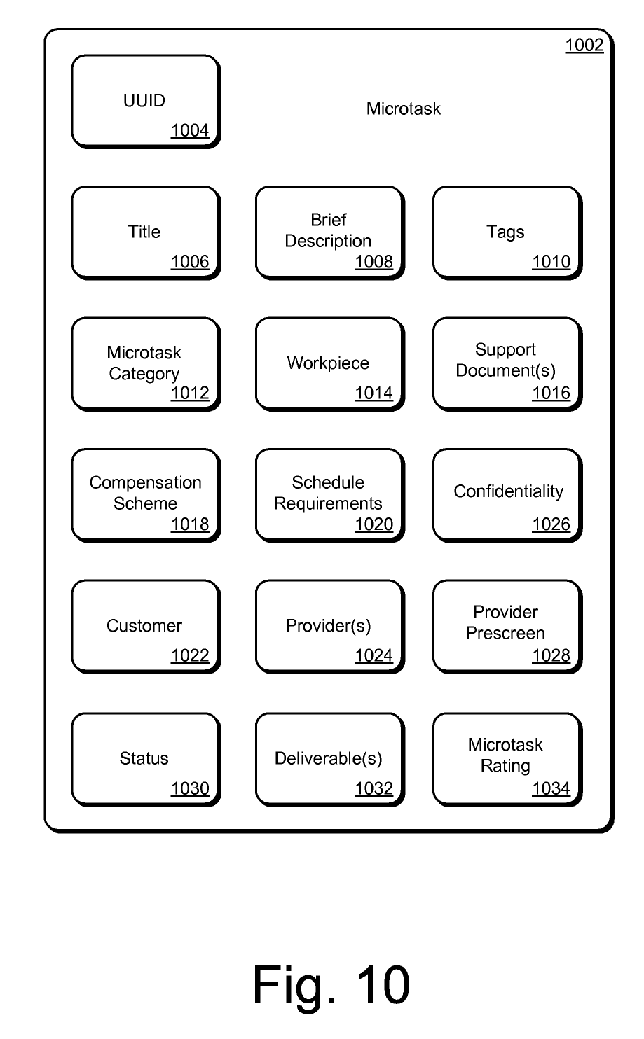

FIG. 9 depicts an example data structure 902 corresponding to a custom microtask in accordance with at least one embodiment of the invention. The data structure 902 may include and/or reference a microtask data 904 structure such as the microtask data structure described below with reference to FIG. 10, as well as custom data 906 particular to the custom microtask associated with the data structure 902. The custom data 906 may include task-specialized metadata such as metadata to help efficiently communicate requirements of specialized microtasks, as well as metadata to help efficiently match microwork providers 208, 210, 212 (FIG. 2) to microwork customers 204, 206, 208, for example, where particular technical and/or specialized skills are required. Microtask editors such as the microtask editor 504 (FIG. 5) may include custom dialogs, wizards, forms, and/or any suitable user interface component for editing and/or displaying custom microtasks, to help efficiently create custom microtasks, and well-parameterized microtasks (e.g., document translation and proofreading) in particular.

FIG. 10 depicts an example microtask data structure 1002 in accordance with at least one embodiment of the invention. For example, the microtask data structure 1002 may be instantiated by the microtask editor 504 (FIG. 5) of the microwork module 502. The microtask data structure 1002 may be communicated between microwork modules 408, 418 (FIG. 4) and the microwork broker 412 incorporated in microtasks 410, 422. The microwork broker 302 (FIG. 3) may maintain microtask data structures 1002 in the microtask database 312.

The microtask data structure 1002 may include a universally unique identifier (UUID) 1004, a title 1006, a brief description 1008 and a set of tags 1010 that categorize the microtask associated with the data structure 1002 in an informal manner (e.g., the tags 1010 may define and/or participate in an informal microwork taxonomy). The microtask data structure 1002 may further include a formal microtask category 1012 (e.g., associated with a formal microwork taxonomy). In particular, microwork participant reputation may be categorized according to the formal microwork categories. The microtask data structure 1002 may still further include a workpiece 1014 and a set of support documents 1016. For example, the workpiece 1014 may include and/or reference one or more documents to be edited by a microwork provider, and the support documents 1016 may include one or more documents describing details of the microtask.

The microtask data structure 1002 may include a compensation scheme 1018 specifying an amount of points, tokens, currency and/or the like to be awarded as compensation for progress on and/or completion of the microtask associated with the data structure 1002. Since, in particular, more than one microwork provider may contribute to completion of the microtask, the compensation scheme may specify how each contributor is to be compensated. Examples include equal award, award based on time started or time spent, deadlines met or missed, award based on reputation, custom criteria, manual award, or any suitable combination thereof. The microtask data structure 1002 may include a set of schedule requirements 1020 including milestones and deadlines.

The compensation scheme 1018 may further specify one or more amounts (“escrow amounts”) to be placed in, and awarded from, escrow (e.g., transferred to or from a microwork participant's account to an escrow account maintained by the microwork broker 412) and to be associated with one or more microtask workflow events, including milestones and deadlines, for example as specified by the set of schedule requirements 1020. For example, the compensation scheme 1018 may specify that an amount be placed in escrow by the microwork provider 414 (FIG. 4) when placing a reservation on the microtask 1002, as well as penalties to that escrow amount to be paid to the microwork customer 402 for failing to meet milestones and/or deadlines as specified by the set of schedule requirements 1020. As another example, the compensation scheme 1018 may specify that an amount be placed in escrow by the microwork customer 402 to be paid to the microwork provider 414 if, the microwork provider 414 having begun work on the microtask 1002, the microwork customer 402 cancels the microtask 1002.

Where disputes arise (e.g., with respect to performance and/or non-performance), and particularly in the case that multiple microwork providers 208, 210, 212 (FIG. 2) are involved, a dispute resolution microtask may be created by one of the involved parties, or automatically by the microwork broker 214 in response to an indication of the dispute associated with a particular microtask. For example, a dispute resolution microtask may be created automatically for some set of microtask categories, or based on participant reputation, or any suitable trigger. The dispute resolution microtask may be matched by the microwork broker 214 to an independent microwork provider who is an expert in dispute resolution, for example, as indicated by their associated provider reputation 706 (FIG. 7) in the dispute resolution microtask category. It may be that the compensation scheme 1018 of the disputed microtask specifies an escrow amount to be set aside in case of dispute, and in this case, the dispute resolution microtask may be paid for using that escrow amount. The microwork broker 214 may even be configured to require that some or all categories of microtask include such a specification. For example, the microwork broker 214 may refuse to publish microtasks 1002 with noncompliant compensation schemes 1018.

The compensation scheme 1018 may reference one or more dispute resolution templates, for example, maintained by the microwork workflow module 318 (FIG. 3) of the microwork broker 214. Such dispute resolution templates may specify dispute resolution workflow including dispute resolution triggers, dispute resolution microtask creation (including specification of multiple dispute resolution microtasks if appropriate), dispute resolution microwork provider selection, dispute resolution microtask workflow management (e.g., the microwork broker 214 may act as the microwork customer for the dispute resolution microtasks), and any suitable dispute resolution workflow rule. Microwork workflow rules may be specified with any suitable rule specification language including any suitable computer programming language.

The compensation scheme 1018 is not limited to static award amounts, but may specify dynamic award amounts, for example, amounts that are determined by a specified formula and/or that change responsive to microtask workflow events and/or the scheduling requirements 1020. In particular, award amounts may change responsive to the number of microwork providers (e.g., the microwork providers 208, 210, 212 of FIG. 2) that have reserved a particular microtask 1002 in order to attract a desired number of reservations. Dynamic award amounts may be based on any suitable set of parameters associated with the microtask 1002 and/or available to the microwork broker 214 where the microtask 1002 is published. Formulas associated with dynamic award amounts may be specified with any suitable specification language including any suitable programming language. For example, the microwork workflow module 318 (FIG. 3) of the microwork broker 302 may establish and/or update current values of dynamic award amounts.

As a particular example of a dynamic award amount associated with the microtask 1002, the compensation scheme 1018 may specify a minimum award amount and a maximum award amount that are not revealed to the microwork providers 208, 210, 212 (FIG. 2). A current offer of compensation for the microtask 1002 that is revealed to the microwork providers 208, 210, 212 may be based on the minimum award amount, the maximum award amount and, for example, the time elapsed since the microtask 1002 was first published, the desired number of microwork provider reservations for the microtask 1002, and the current number of microwork provider reservations for the microtask 1002. For example, the current offer of compensation may be set initially at the minimum award amount and incremented at a specified rate towards the maximum award amount until the current number of microwork provider reservations for the microtask 1002 matches the desired number of microwork provider reservations. Once the desired number of microwork provider reservations is achieved (e.g., one), the current offer of compensation may be reduced to zero.

In this particular example, the microwork provider 208, 210, 212 (FIG. 2) is awarded compensation at microtask completion based on the current offer at the time the microwork provider 208, 210, 212 placed the reservation. However, each embodiment of the invention is not so limited. For example, in the case that multiple microwork provider reservations are desired for the microtask 1002, the compensation scheme 1018 may specify that compensation at completion be based on some statistical function (e.g., an average) of the current offers at the time reservations were placed in order to encourage early reservations.

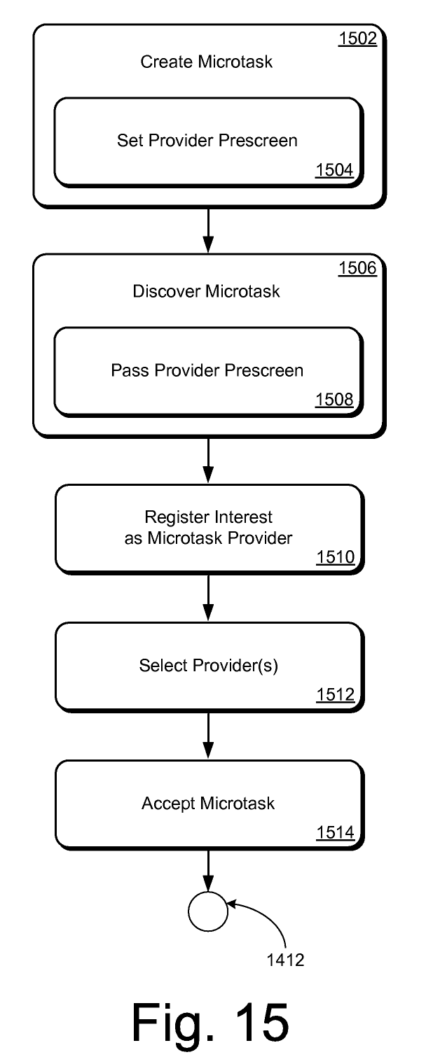

The microtask data structure 1002 may include a reference to the microwork customer 1022 who created the microtask, as well as any microwork providers 1024 who have registered interest (e.g., as described below with reference to FIG. 15), requested access, reserved the microtask, started work on the microtask, sent a status update with respect to the microtask, completed the microtask, and/or are otherwise associated with the microtask. The microtask data structure 1002 may include a confidentiality structure 1026, for example, specifying if an access request is required to view portions of the microtask such as the workpiece 1014. The microtask data structure 1002 may include a provider prescreen specification 1028 specifying criteria required by microwork providers to view and/or reserve the microtask, for example, a reputation threshold.

The microtask data structure 1002 may include a status 1030 specifying the current status of the associated microtask, for example, not published, published, reserved, in progress, completed, paid, and the like. The microtask data structure 1002 may further include a set of deliverables 1032, for example, a desired deliverable may be the workpiece transformed as required by the brief description, or the deliverable may be a translation of the workpiece.

The microtask data structure 1002 may further include a microtask rating 1034 that rates the microtask itself (e.g., on a scale of zero to five stars) independent of the microwork customer and/or provider. For example, the microtask may be particularly desirable (e.g., high-value), or offensive (e.g., have an obscene description) or otherwise inappropriate (e.g., request an illegal act). Some microwork brokers such as the microwork broker 302 (FIG. 3) may allow microwork providers 208, 210, 212 (FIG. 2) to filter microtask search results based on the microtask rating 1034 and so, for example, avoid viewing offensive and otherwise inappropriate microtasks. In microwork communities where this is a significant issue, the microwork broker 302 may be configured to filter low-rated microtasks by default.

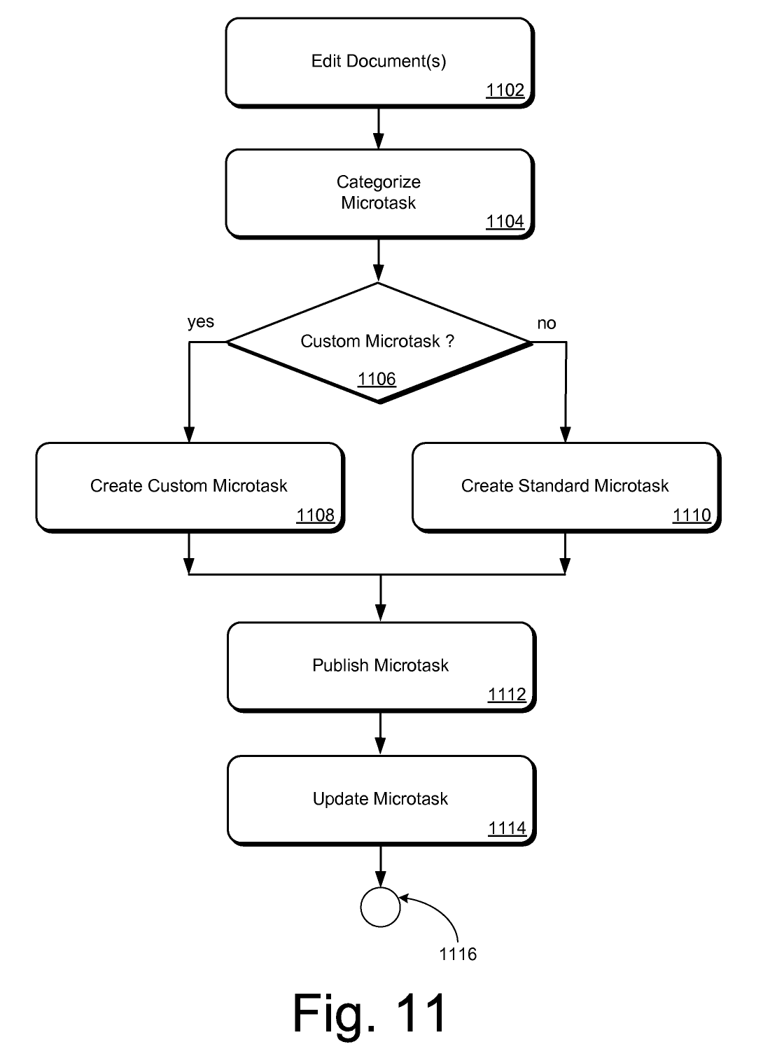

Having described structural aspects of the microwork architecture 200 (FIG. 2) in some detail, the description now turns to procedures and steps thereof that may be performed by components of the architecture 200. FIGS. 11, 12 and 13 depict example steps that may be performed by a microwork customer in accordance with at least one embodiment of the invention. At step 1102, one or more documents may be edited. For example, the microwork customer 402 (FIG. 4) may edit the document(s) 406 with the document editor 404. During document editing, the microwork customer 402 may identify a suitable microtask 410.

At step 1104 the microtask may be categorized. For example, the microtask may be categorized manually or automatically by virtue of a context in which categorization was invoked (e.g., a particular document editor 404 menu item). At step 1106, it may be determined if the microtask categorization determined at step 1104 corresponds to a custom microtask. For example, some subset of all microtask categories may correspond to custom microtasks such as the custom microtask 902 (FIG. 9), and the microtask categorization module 506 (FIG. 5) may maintain a list of those microtask categories that do correspond to custom microtasks. If the categorization does correspond to a custom microtask, a procedure incorporating steps depicted in FIG. 11 may progress to step 1108. Otherwise, the procedure will progress to step 1110. At step 1108, a custom microtask 902 may be created. At step 1110, a standard microtask 1002 (FIG. 10) may be created. At either step, for example, the microwork module 408 (FIG. 4) may utilize one or more user interface elements to collect the information required to create the microtask 410. In the case of the custom microtask 902, the user interface may prompt for additional custom data 906.

At step 1112, the microtask created at step 1108 or 1110 may be published. For example, the microtask 410 (FIG. 4) may be published at the microwork broker 412. The microwork broker 412 may be configured to detect and disallow publication of microtasks by malicious users, for example, users publishing in bad faith merely as an advertising mechanism (e.g., “spammers”). Any suitable content filtering, rate limiting and/or other bad faith advertising (e.g., “spam”) reduction measure may be incorporated into the microwork broker 412. Uncontrolled, such malicious users may undermine microwork marketplace trust and/or efficiency.

At step 1114, the microtask published at step 1112 may be updated. In particular, the published microtask may be canceled, but any suitable aspect of the published microtask may be modified subject to the policies of the microwork broker 412. Each aspect (e.g., configuration of the modules depicted in FIG. 10) of the published microtask may be modifiable or not modifiable during each step of microtask workflow (e.g., as depicted by the flowcharts of FIGS. 11-16), and the microwork broker 412 may be configured to allow and/or disallow modifications in accordance with the needs of the associated microwork community. For example, modification of the compensation scheme 1018 (FIG. 10) may be disallowed after one or more microwork providers have started work on (e.g., reserved) the microtask 1002, but allowed before then. As another example, one microwork broker 412 may be configured to allow updates to the microtask description 1008 once work has started, but another microwork broker may disallow such updates to prevent “bait and switch” tactics on the part of unscrupulous microwork customers.

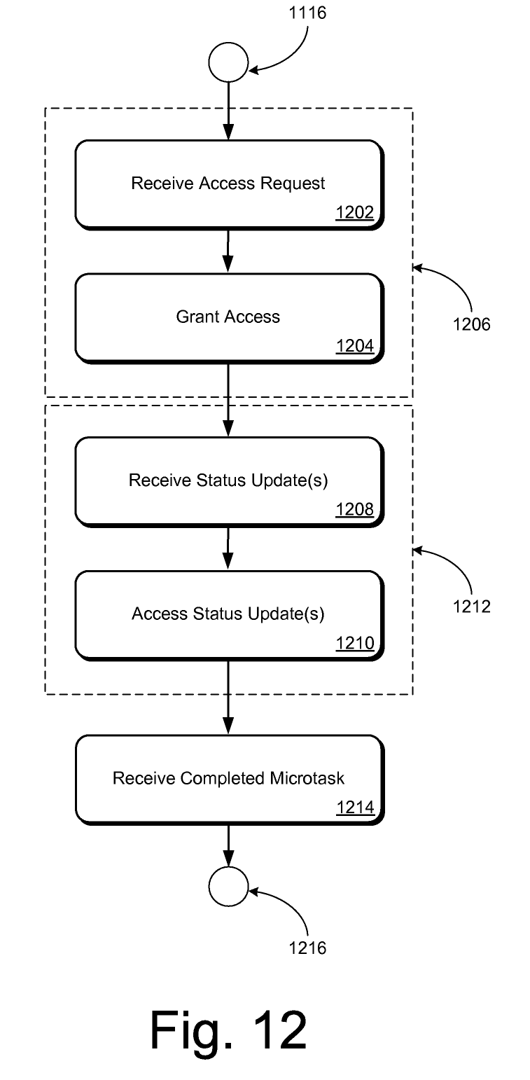

When the compensation scheme 1018 (FIG. 10) associated with the microtask 410 specifies one or more escrow amounts, the publication of step 1112 and/or the update of step 1114 may be associated with a transfer of a particular escrow amount to or from escrow. The circle labeled 1116 on FIG. 11 and FIG. 12 is a diagrammatic device that indicates that the steps depicted in FIG. 12 may be performed following the steps depicted in FIG. 11.

At step 1202, a microtask access request may be received. For example, as part of the creation of the microtask 410 (FIG. 4), the microwork customer 402 may have specified that access to microtask 410 contents required explicit authorization. The microwork provider 414 may have discovered the published microtask 410 and been interested enough to request such access. Any suitable aspect of the microtask 410 (e.g., suitable aspects described with reference to FIG. 10) may require authorization to access. In addition suitable workflow actions with respect to the microtask 410 may also require authorization. For example, where microtask reservation is possible, authorization may be required to place a reservation on the microtask 410.

At step 1204, access may be granted. For example, the microwork customer 402 may assess the request with a set of user interface elements (as well as, for efficiency's sake, information helpful in making the decision to grant access such as a suitable presentation of the associated provider reputation 706 of FIG. 7) and may select an approve element of the user interface resulting in a microwork protocol message being sent to the microwork broker 412 indicating that the microwork provider 414 is approved for access. Portions of the microtask 410 may be encrypted and step 1204 may include sending a decryption key and/or passphrase to the requesting microwork provider 414.

Steps 1202 and 1204 are surrounded by a dashed box 1206 to indicate that they are optional. Not every microtask will require explicit approval to access and not every microwork broker will be configured to enforce a requirement for such approval. On the other hand, some microtasks may specify multiple required authorizations. For example, a first authorization may be required to access microtask 410 (FIG. 4) contents, and a second authorization may be required to reserve the microtask 410. Where multiple authorizations are required, steps 1202 and 1204 may be repeated until each of the required authorizations has been granted. Where appropriate, multiple authorizations may be granted at step 1204.

At step 1208, one or more status updates may be received. For example, the microwork customer 402 (FIG. 4) may receive status updates from the microwork broker 412 and/or the microwork provider. In particular, such status updates may include: microtask reserved, work in progress, milestone met, microtask completed, and the like. At step 1210, the status updates may be accessed. For example, the microwork customer 402 may access the status updates with one or more user interface elements such as a graphical user interface dialog of the microwork module 502 (FIG. 5), at a web site maintained by the microwork broker 412, the microwork customer 402 may receive updates in e-mail, and/or by any suitable notification mechanism including, as will be apparent to one of skill in the art, notification mechanisms implemented with self-organizing peer-to-peer networks and/or cloud-based services. Again, steps 1208 and 1210 are enclosed in the dashed box 1212 to indicate that they are optional in that, for example, status updates may take place manually and/or “out of band” using a suitable third party communication mechanism.

Status updates are an example of microwork customer-provider communication that may be facilitated by the microwork broker 412. Other such communication may be similarly facilitated, for example, microwork provider interviews and dispute resolution. Microwork communication facilities may include integrated communication clients, for example, integrated instant messaging (IM) clients or short message service (SMS) text message clients. Integrated communication clients may enhance communication efficiency, for example, by providing a reliable communication channel, and/or by enhancing communications with information available from a particular microtask context (e.g., a microtask identifier) and/or from the microwork context in general (e.g., with respect to marketplace policies maintained by a particular microwork broker such as the microwork broker 412). Any suitable data accessible by integrated communication clients may be utilized to enhance microwork-related communications.

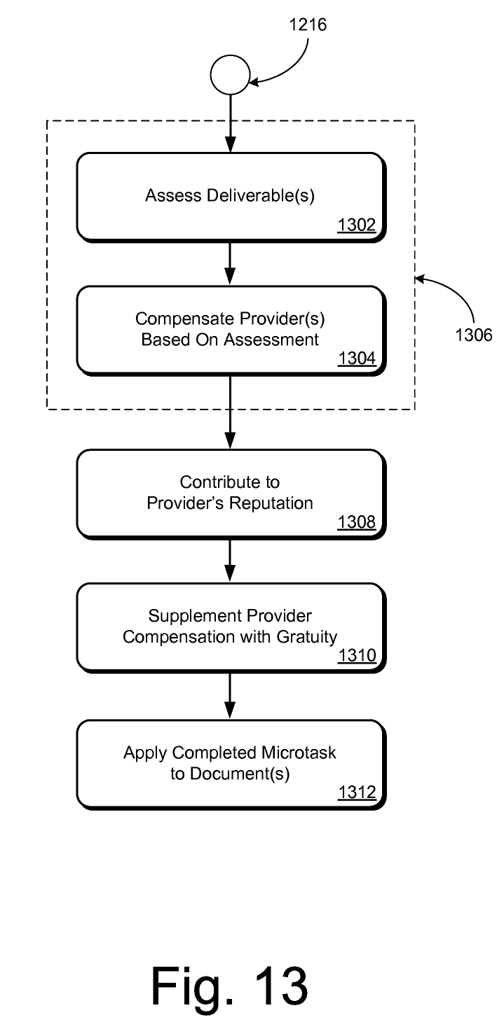

At step 1214, the completed microtask may be received. For example, the microwork provider 414 (FIG. 4) may complete the microtask 410, and update the microwork broker 412 with the completed microtask 422. The microwork broker 412 may then notify the microwork customer 402 and deliver the completed microtask to the microwork customer 402. Alternatively, the microwork provider 414 may send the completed microtask directly to the microwork customer 402. The circle labeled 1216 on FIG. 12 and FIG. 13 is a diagrammatic device that indicates that the steps depicted in FIG. 13 may be performed following the steps depicted in FIG. 12.

At step 1302, the deliverables contained in the completed microtask may be assessed. For example, the microwork customer 402 (FIG. 4) may utilize the microtask assessor module 520 (FIG. 5) of the microwork module 408 to manually or automatically assess the deliverables. Alternatively, the deliverables may be assessed by a third party and/or one or more other microwork participants. At step 1304, compensation may be awarded to the microwork provider(s) based on the assessment of step 1302. For example, the microwork broker 412 may automatically award compensation based on the assessment made at step 1302. Automatic award of compensation may include transfer of award amounts between participant accounts 308 (FIG. 3) as directed by the microwork workflow module 318 of the microwork broker 412. Alternatively, the microwork customer 402 may manually award compensation. In particular, the microwork customer 402 may facilitate the compensation of step 1304 by communicating the assessment of step 1302 to the microwork broker 412. Furthermore, steps 1302 and 1304 are enclosed in a dashed box 1306 to indicate that the two steps may be integral.

At step 1308, the microwork customer 402 (FIG. 4) may contribute to the reputation of the one or more microwork providers that completed the microtask. For example, such contribution may be a rating and/or a comment, and may be entered using one or more user interface elements of the microtask feedback module 522 (FIG. 5) of the microwork module 408. At step 1310, the microwork customer may optionally supplement microwork provider compensation with a gratuity. At step 1312, the completed microtask may be applied to the document(s). For example, the microtask solution module 516 (FIG. 5) of the microwork module 408 may automatically apply the completed microtask deliverable 1032 (FIG. 10) to the document(s) 406. However, not all microtasks will be susceptible to automatic application, and the microtask deliverable may even be a set of instructions on how to make desired modifications, a revised document, or simply the answer to a question. In such cases, step 1312 may not be performed, or may produce a null result.

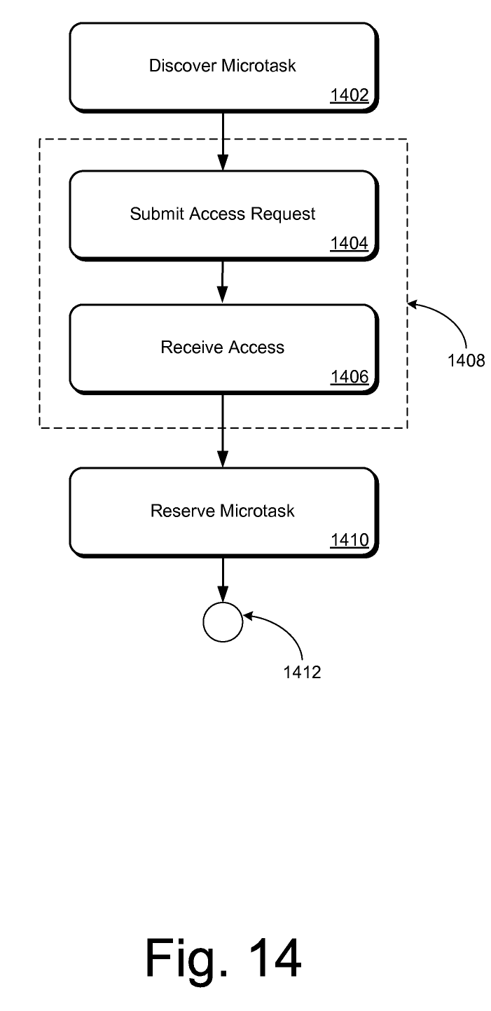

FIGS. 14, 15 and 16 depict example steps that may be performed by a microwork provider in accordance with at least one embodiment of the invention. At step 1402, a microtask may be discovered. For example, the microwork provider 414 (FIG. 4) may discover the microtask 410 published by the microwork customer 402. It may be that the microwork provider 402 has specified that authorization is required to view one or more portions of the microtask, accordingly, at step 1404 a suitable access request may be submitted and, at step 1406 access may be granted. If access is not granted, then a procedure incorporating steps depicted in FIG. 14 can not proceed, and the procedure may return to step 1402 to discover further microtasks of interest. As for FIG. 12, steps 1404 and 1406 are enclosed in dashed box 1408 to indicate that they are optional.

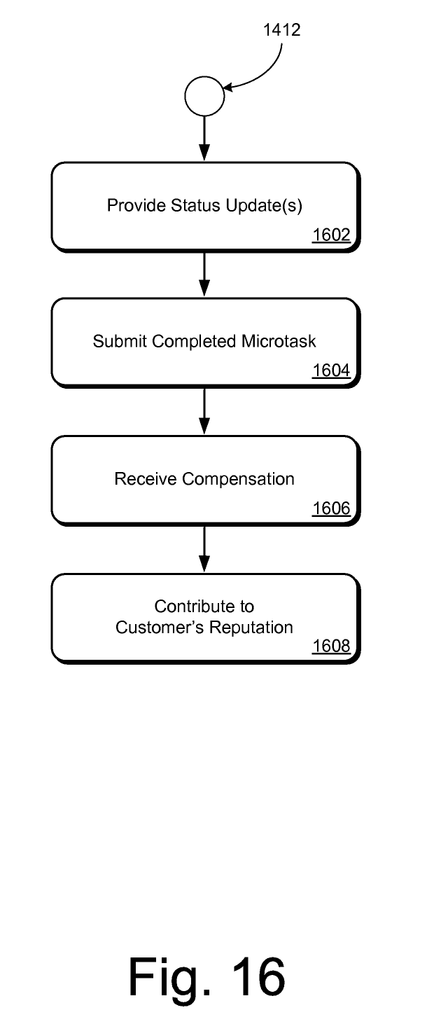

It may be that the microtask 410 (FIG. 4) is reservable (e.g., as specified at creation time). At step 1410, such a microtask may be reserved. Microtask reservation may take several forms depending on the configuration of the microwork broker 412 and/or the microtask 410. As a first example, the microwork provider 414 may reserve the microtask 410 exclusively for some period of time, preventing wasted effort if the compensation scheme 1018 (FIG. 10) specifies that the first to deliver the completed microtask gets all available compensation. However, the compensation scheme 1018 may be more sophisticated allow for multiple simultaneous microwork providers 414 to work on the same microtask 410 and to be suitably compensated. In such a case, the reservation need not be exclusive, although it may be that the number of providers that can reserve a particular microtask is limited. It may be that reserving a microtask is simply an indication to the microwork broker 412 and/or customer 402 that the reserving microwork provider 414 is working on the microtask 410, without any particular guarantee of compensation.

Where specified by the compensation scheme 1018, the act of placing a reservation on the microtask 410 may also be associated with a transfer of an escrow amount from the reserving microwork provider's 414 account as an encouragement for the microwork provider 414 to work diligently on the microtask 410 or risk possible forfeit of the escrow amount. Where the compensation scheme 1018 specifies a dynamic award amount, the act of placing a reservation on the microtask 410 may fix the award amount for the reserving microwork provider 414 to the current value of the dynamic award. The circle labeled 1412 on FIGS. 14, 15 and 16 is a diagrammatic device indicating that the steps depicted in FIG. 16 may be performed following the steps depicted in FIG. 14 or FIG. 15.

FIG. 15 depicts steps alternate to those of FIG. 14 in that instead of reserving a microtask, the microwork provider 414 (FIG. 4) merely registers interest and waits on the microwork customer 402 to make a selection from among those who register. At step 1502, during microtask creation, a provider prescreen 1028 (FIG. 10) may be set (step 1504). For example, the microwork customer 402 may specify a minimum required microwork provider reputation score in order for the created microtask 410 to be visible to searching microtask providers. At step 1506, during microtask discovery, it may be that a provider prescreen test must be passed (step 1508) in order to find the microtask created at step 1502. For example, the microwork broker 412 (FIG. 4) may filter search results according to the provider prescreen set at step 1504. Making the microtask 410 available for discovery, for example, by publishing the microtask at step 1112 (FIG. 11), may be considered a solicitation for registrations of interest by microwork providers.

At step 1510, interest may be registered as a microwork provider for the discovered microtask. For example, the microwork provider 414 (FIG. 4) may register interest with the microwork broker 412 and/or the microwork customer 402. At step 1512, one or more microwork providers may be selected from among those interested. The selection may be manual or automated according to a set of criteria specified by the microwork customer 402. At step 1514, the selection of step 1512 may be accepted. For example, the microwork provider 414 may be notified of the selection by the microwork broker 412 and respond to the notification. It may be that one or more of the providers do not accept (e.g., the selection process took too long and they found other work in the meantime), however in this case a procedure incorporating steps of FIG. 14 can not proceed. Similar to step 1410 (FIG. 14), it may be that the act of accepting the selection is associated with a transfer of an escrow amount from the accepting microwork provider's 414 account.

Regardless of whether the steps FIG. 14 or 15 are performed, a procedure incorporating such steps may then proceed to step 1602 of FIG. 16. At step 1602, zero or more status updates may be sent. For example, the microwork provider 414 (FIG. 4) may provide such updates. At step 1604, the completed microtask, including one or more deliverables, may be submitted. For example, the microwork provider 414 may submit the completed microtask 422 to the microwork broker 412 and/or the microwork customer 402. Even when the completed microtask 422 is not submitted to the microwork broker 412, the microwork provider 414 may notify the microwork broker 412 of the completion of the microtask 422, for example, to facilitate fair determination of the provider reputation 706 (FIG. 7) associated with the microwork provider 414. Proper association of the identity of the microwork provider 414 with the completed microtask 422, for example, including the UUID 804 (FIG. 8) associated with the microwork provider 414 in the completed microtask 422 and/or cryptographically signing the completed microtask 422, may facilitate association of the completed microtask 422 with the provider reputation 706, particularly when the completed microtask 422 is not submitted to the microwork broker 412.

At step 1606, compensation may be received. For example, the microwork broker 412 may update the participant accounts 308 (FIG. 3) corresponding to the microwork customer 402 and the microwork provider 414 in accordance with the compensation scheme 1018 (FIG. 10) associated with the completed microtask 422. Where the compensation scheme 1018 specifies one or more escrow amounts and associated conditions, settlement (e.g., in accordance with the associated conditions) of such escrow amounts may be incorporated into step 1606. At step 1608, the microwork provider 414 may contribute to the reputation of the microwork customer 402. In particular, it may be that the assessment of step 1302 (FIG. 13) was poor, in which case the microwork provider 414 may receive little or no compensation at step 1606, in which case the contribution to the reputation of the microwork customer 402 is unlikely to be favorable.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to an embodiment of the invention.

Preferred embodiments of the invention are described herein, including the best mode known to the inventors for carrying out the invention. Variations of those preferred embodiments may become apparent to those of ordinary skill in the art upon reading the specification. The inventors expect skilled artisans to employ such variations as appropriate, and the inventors intend for the invention to be practiced otherwise than as explicitly described herein. Accordingly, embodiments of the invention include all modifications and equivalents of the subject matter recited in the following claims as permitted by applicable law.

1. At least one computer-readable medium having thereon computer-executable instructions for affordances supporting microwork comprising:
editing at least one document with a document editor capable of facilitating creation of microtasks, the at least one document associated with at least a first identifier;
creating a microtask for the at least one document, the microtask associated with the first identifier and at least a second identifier; and
submitting the microtask to a microwork broker.

2. The at least one computer-readable medium of claim 1, wherein at least one of the creating and the submitting are performed by a microwork module integral to the document editor.

3. The at least one computer-readable medium of claim 1, wherein the computer-executable instructions further comprise:
receiving the completed microtask from the microwork broker; and
applying the completed microtask to the at least one document.

4. The at least one computer-readable medium of claim 3, wherein at least one of the receiving and the applying are performed by a microwork module integral to the document editor.

5. The at least one computer-readable medium of claim 1, wherein the computer-executable instructions further comprise:
assessing a deliverable associated with the microtask; and
facilitating automatic compensation of a provider of the deliverable based on, at least, the assessment.

6. The at least one computer-readable medium of claim 5, wherein the assessment is based on, at least, a rating of the deliverable by each of a plurality of microwork participants independent of the microwork customer and the provider.

7. The at least one computer-readable medium of claim 1, wherein:
the creating the microtask comprises:
specifying a workpiece; and
specifying that the workpiece requires authorization to view; and
the computer-executable instructions further comprise receiving a request for authorization to view the workpiece.

8. The at least one computer-readable medium of claim 1, wherein the creating the microtask comprises specifying that the microtask is reservable.

9. The at least one computer-readable medium of claim 8, wherein the creating the microtask further comprises specifying a reservation timeout period after which a microtask reservation will expire.

10. The at least one computer-readable medium of claim 1, wherein the creating the microtask comprises specifying that the microtask is non-exclusively reservable.

11. The at least one computer-readable medium of claim 1, wherein the computer-executable instructions further comprise:
soliciting registrations of interest in the microtask from one or more microwork providers; and
facilitating selection of at least one microwork provider for the microtask from among the microwork providers for which registrations of interest in the microtask have been received.

12. The at least one computer-readable medium of claim 1, wherein:
the creating the microtask comprises specifying a microwork provider prescreening filter; and
the computer-executable instructions further comprise soliciting registrations of interest in the microtask from potential microwork providers that pass the microwork provider prescreening filter.

13. The at least one computer-readable medium of claim 1, wherein the creating the microtask comprises specifying a compensation scheme for a plurality of microwork providers:

14. The at least one computer-readable medium of claim 1, wherein the creating the microtask comprises specifying a compensation scheme that includes at least one dynamic award amount.

15. A computerized system incorporating affordances supporting microwork comprising a microtask module configured to, at least:
create a microtask for a document that is at least partially independent of document content;
anonymize at least part of the document; and
apply the completed microtask to the document.

16. The computerized system of claim 15, wherein:
the microtask comprises a request to format the document; and
as part of the applying the completed microtask to the document, the microtask module is further configured to format the document in accordance with the completed microtask.

17. The computerized method of claim 15, wherein, as part of the anonymizing the at least part of the document, the microtask module is further configured to replace at least some text of the document with filler text having at least one presentation characteristic similar to the at least some text.

18. A computerized method incorporating affordances supporting microwork comprising:
providing at least one completed microtask to a microwork broker;
facilitating association with a reputation based on, at least, the at least one completed microtask; and
receiving access to at least one uncompleted microtask based on, at least, the reputation.

19. The computerized method of claim 18, wherein:
the method further comprises submitting a search request for uncompleted microtasks to the microwork broker; and
the receiving access to the at least one uncompleted microtask comprises the at least one uncompleted microtask being included in a set of search results corresponding to the search request.

20. The computerized method of claim 18, wherein the receiving access to the at least one uncompleted microtask comprises receiving access to a document associated with the at least one uncompleted microtask.
